(19) United States
(12) Patent Application Publication
(10) Pub. No.: US 2019/0266655 A1
(43) Pub. Date: Aug. 29, 2019

(54) COGNITIVE MIRROR

(71) Applicant: INTERNATIONAL BUSINESS MACHINES CORPORATION, Armonk, NY (US)

(72) Inventors: Malathy Desikan, Visakhapatnam (IN); Divya Mantha, Akkayapalem (IN); Kavya Mantha, Visakhapatnam (IN); Sailaja S. Perumalla, Visakhapatnam (IN)

(21) Appl. No.: 15/904,483

(22) Filed: Feb. 26, 2018

(51) Int. Cl. G06Q 30/06; G06F 3/16

(52) U.S. Cl. CPC G06Q 30/0631; G06F 3/167; G06Q 30/0633; G06Q 30/0641

(57) ABSTRACT

A method, computer system, and a computer program product for cognitive suggestions is provided. The present invention may include launching a cognitive beauty suggestion application. The present invention may include receiving a plurality of user data from a user of the cognitive beauty suggestion application. The present invention may then include determining one or more suitable products based on the received plurality of user data. The present invention may lastly include outputting a list of the determined one or more suitable products to the user of the cognitive beauty suggestion application.

### STATEMENT REGARDING PRIOR DISCLOSURES BY THE INVENTOR OR A JOINT INVENTOR

Aspects of the present invention have been disclosed by the inventors in the presentation “Cognitive Mirror,” presented to the public at IVH International Women's Day 2017 on Mar. 8, 2017. The following disclosure is submitted under 35 U.S.C. § 102(b)(1)(A).

### BACKGROUND

The present invention relates generally to the field of computing, and more particularly to cognitive expert systems.

Many cosmetic companies produce products intended to fill similar needs, thereby making it difficult for a consumer to choose the product that is most suitable for him or her, given a set of specific considerations. As a result, consumers may be more inclined to take suggestions from friends or family, depend on internet research, or determine the effectiveness of comparable products based on trial and error use.

### SUMMARY

Embodiments of the present invention disclose a method, computer system, and a computer program product for cognitive suggestions. The present invention may include launching a cognitive beauty suggestion application. The present invention may include receiving a plurality of user data from a user of the cognitive beauty suggestion application. The present invention may then include determining one or more suitable products based on the received plurality of user data. The present invention may lastly include outputting a list of the determined one or more suitable products to the user of the cognitive beauty suggestion application.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for cognitive suggestions according to at least one embodiment;

FIG. 3 is an example graphical user interface (GUI) of the cognitive suggestion program according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for cognitive suggestions. As such, the present embodiment has the capacity to improve the technical field of cognitive expert systems by reducing the time and money spent on unsuitable cosmetic products by advising consumers of products which may be suitable for their specific skin type. More specifically, the cognitive suggestion program may receive as input a set of parameters such as occasion, event duration, event location, and an uploaded photograph or photographs of the program's user. The cognitive suggestion program may also maintain a database of existing skincare, and together with image processing technologies, the cognitive suggestion program may suggest a suitable cosmetic choice for the given user. The cognitive suggestion program may further suggest any possible negative effects a cosmetic choice may have on the program's user, given the user's inputted location and photographs revealing the user's skin type.

As described previously, many cosmetic companies produce products intended to fill similar needs, thereby making it difficult for a consumer to choose the product that is most suitable for him or her, given a set of specific considerations (e.g., skin type, allergies, intended result). As a result, consumers may be more inclined to take suggestions from friends or family, depend on internet research, or determine the effectiveness of comparable products based on trial and error use. However, it may be costly and time consuming to seek advice from others and test numerous products before finding a suitable match.

Therefore, it may be advantageous to, among other things, use a cognitive solution and image processing capabilities to read the skin type of a given user and output a list of products and compositions that may be suitable for the user based on the user's characteristics and needs.

According to at least one embodiment, the cognitive suggestion program may be a user-friendly advisor which analyzes the skin type of a given user based on inputted photographs and information and, accordingly, provides a list of satisfactory products and their compositions.

According to at least one embodiment, the cognitive suggestion program may permit a user to decide on a product that best suits his or her needs based on an outputted list of components of each recommended product. The user may determine that certain products are better for him or her than others based on the user's allergies or testing history. With regard to allergies, a user may input a list of ingredients to which the user is allergic into the cognitive suggestion program. The user may request that the cognitive suggestion program avoid recommending products containing an inputted ingredient which may cause an allergic reaction in the user. The cognitive suggestion program may compare the list of inputted ingredients to a list of ingredients contained within a recommended product, and may remove from the list of recommended products any products to which the user may be allergic (e.g., any product containing an ingredient to which the user has indicated an existing allergy). The user may alternatively permit the cognitive suggestion program to display all recommended products, and the user may thereafter compare ingredients of recommended products to an inputted list of ingredients to which the user is allergic, to determine whether the recommended product should be used. Use of a product may include testing the recommended product for a period of time (e.g., one week, one month, etc.) to confirm that no allergic reaction or unfavorable appearance results. Testing history may include outcomes and results from a user's prior use of a recommended product.

According to at least one embodiment, a user of the cognitive suggestion program may input (upload) a photograph of another person (e.g., a celebrity) and may obtain information about the products and techniques used by the person in the uploaded photograph. An uploaded photograph may depict an individual with any hair color, any hairstyle, any style of dress, any skin tone, and any makeup application, who may not resemble the user of the cognitive suggestion program. The cognitive suggestion program may ask the user what aspect of the photograph is admired (e.g., hair color, highlights, makeup application) and may determine the techniques used to achieve the desired look. Using this technology, the user of the cognitive suggestion program may recreate or mimic an impressive look using the correct products and techniques. If style of dress is admired, the cognitive suggestion program may provide online links to websites where similar clothing may be purchased.

According to at least one embodiment, the cognitive suggestion program may suggest a style of clothing, jewelry, and hair to complement the user's cosmetic choices for a given event. In this instance, the cognitive suggestion program may first receive photographs of the user as input so that the user's facial structure, skin texture, and effect of external climate may be determined. Event, weather, and geographic location details may also be inputted into the cognitive suggestion program. Based on the received information, in addition to a maintained database of the latest fashion and style trends, the cognitive suggestion program may suggest a style of dress, jewelry, and hair for the user.

According to at least one embodiment, the cognitive suggestion program may maintain and reference a database of clothing items which are sold at specified stores, and may suggest cosmetic products and makeup techniques that complement the articles of clothing, based on the user's inputted style preference and event details.

According to at least one embodiment, the cognitive suggestion program may permit users to connect and form groups within the application. Within a formed group, users may share information on personal inventory, personal style preference, color of preferred attire, etc. so that coordination for a common outfit at a group event may be made easier. Members of a group may be able to view inputted inventory of other group members to discover similar coordinating pieces.

For example, a group may be formed among members of a dance company which is set to perform at a local festival. A member of the group may wish to purchase something to match the outfits of other members of the group. She may visit a local shop and, while out at the shop, she may retrieve and view her group member's inventory within the cognitive suggestion application, so that she may explain what she is searching for and may be better assisted by shop personnel. Alternatively, members of a group may wish to wear different, albeit similar, clothing styles, and may utilize the cognitive suggestion program to display clothing choices of other group members to assist in purchasing coordinating outfits which are not identical.

Continuing with the above example, the cognitive suggestion program may further display clothing options from an online website on an inputted image of the user, so that the user may appreciate the fit and style of the clothing prior to purchasing it. The user may utilize this feature to appreciate the fit and style of clothing during a period of weight gain or weight loss (e.g., before, during, or after a pregnancy, when the user is interested in articles of clothing not previously worn, and the user is not certain what size, cut, or style of clothing to purchase).

According to at least one embodiment, with regular use of this solution, the cognitive suggestion program may determine that a user is prone to a skin disorder and may give recommendations on skin care techniques and products that may remedy, benefit, or simply not affect, the determined skin disorder. Any prediction or indication of possible skin disorders may result in a notification of the same to the program's user, and may be made based on the maintained collection of user images, diet information, lifestyle information, and climatic and environmental conditions. For example, a detection of dark circles or wrinkles may result in a notification to the program's user that proper sleep is essential for healthy skin and may resolve the dark circles that have begun appearing around the user's eyes.

According to at least one embodiment, with growing popularity and a maintained database of suggested products in each global region, the cognitive suggestion program may assist cosmetic companies and the like in deriving an analysis of most demanded and most used cosmetic products in each region. An analysis of maintained climatic information may further assist cosmetic companies in drawing connections between the products used, the ingredients which comprise those products, and the climate in which the user lives.

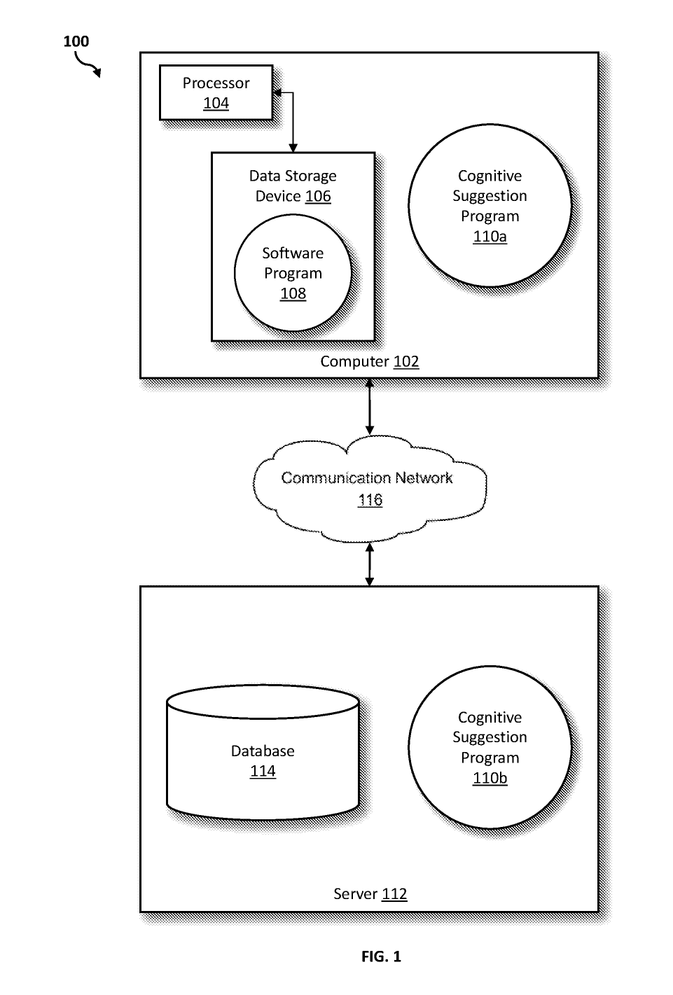

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a cognitive suggestion program 110a. The networked computer environment 100 may also include a server 112 that is enabled to run a cognitive suggestion program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

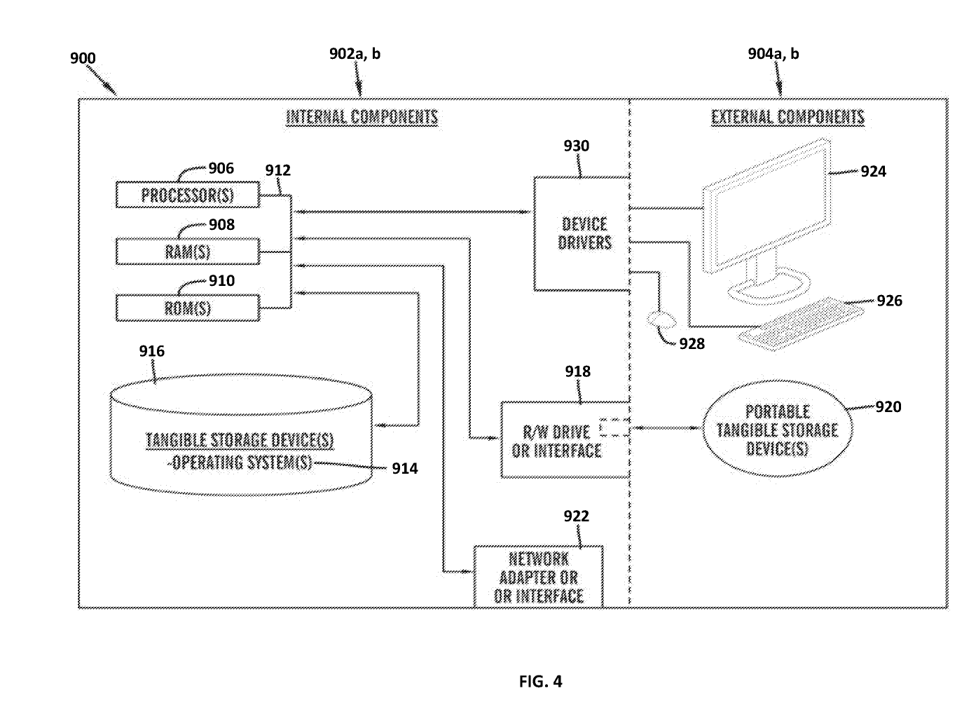

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the cognitive suggestion program 110a, 110b may interact with a database 114 that may be embedded in various storage devices, such as, but not limited to a computer/mobile device 102, a networked server 112, or a cloud storage service.

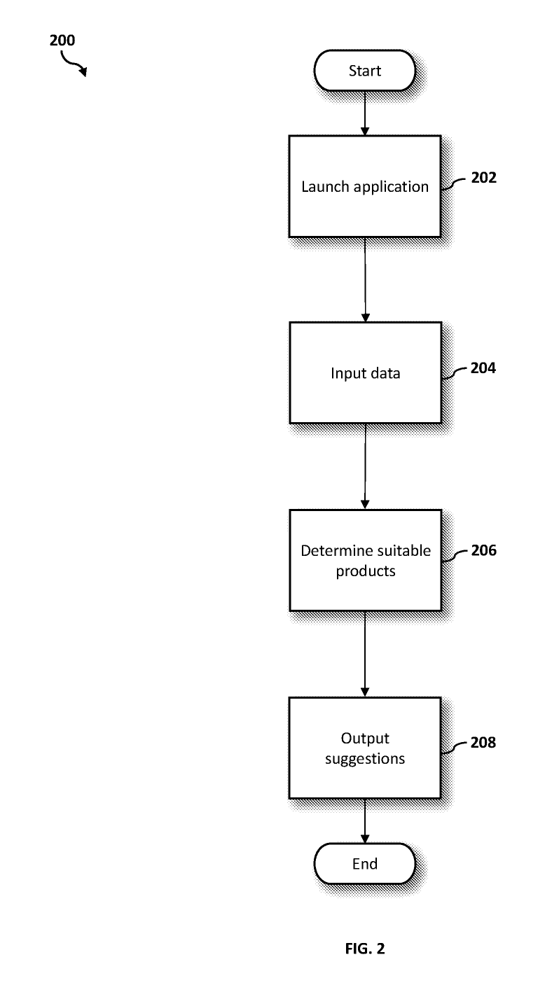

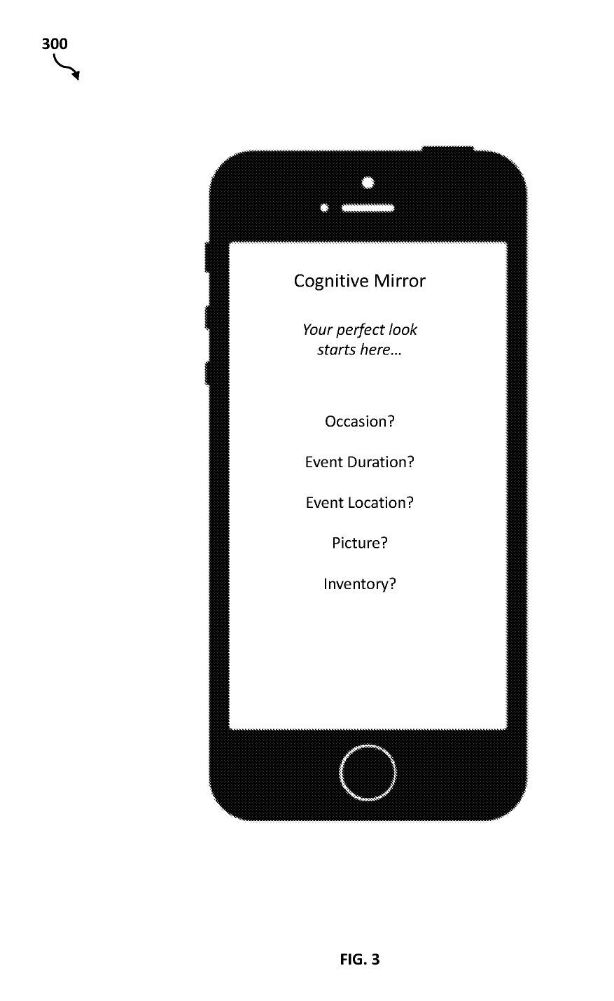

According to the present embodiment, a user using a client computer 102 or a server computer 112 may use the cognitive suggestion program 110a, 110b (respectively) to determine the cosmetic products that are most suitable for him or her given a set of inputted photographs and considerations. The cognitive suggestion method is explained in more detail below with respect to FIGS. 2 and 3.

Referring now to FIG. 2, an operational flowchart illustrating the exemplary cognitive suggestion process 200 used by the cognitive suggestion program 110a and 110b according to at least one embodiment is depicted.

At 202, the cognitive suggestion application is launched. The cognitive suggestion program 110a, 110b may be a mobile application on the user's smartphone or tablet, or may be embedded within an Internet of Things (IoT) enabled mirror. The user may launch the cognitive suggestion program 110a, 110b by speaking a verbal command into the mobile application or IoT enabled mirror. The mobile device or IoT enabled mirror may be further enabled with photograph capabilities, either to take a photograph using the device or to upload a photograph onto the device.

For example, a user Christina has an IoT enabled mirror, with the cognitive suggestion program 110a, 110b, on her bathroom vanity. When she wakes up in the morning, she realizes that the temperature has significantly dropped from the day before and the air around her feels dry. She believes that she might need to alter her skin care regimen so her skin does not dry and begin to peel. She walks in front of her IoT enabled mirror and begins by issuing a voice command to turn the mirror on.

At 204, the user inputs data into the cognitive suggestion program 110a, 110b. The cognitive suggestion program 110a, 110b may receive as input photographs of the user, information regarding the occasion the user is seeking cosmetic products for, the event duration, and the event location (e.g., geographic location and/or whether the event is indoors or outdoors). The user may further choose to input a list of products that he or she has presently available (e.g., the user's inventory), or the user may choose to seek out a new product and expand his or her inventory. The user may inform the cognitive suggestion program 110a, 110b of the products which are readily available to him or her by uploading photographs or descriptive information concerning each product in the user's inventory. The user may limit the scope of new products suggested by the cognitive suggestion program 110a, 110b by indicating a preferred distance to new products from the user's location.

The user may also input information concerning the climatic conditions (e.g., weather conditions). For example, the user may indicate that he or she is planning on attending a party in Vizag (i.e., Visakhapatnam, India) where humidity is likely to be increased based on the city's proximity to the ocean. To determine Vizag's local weather, the cognitive suggestion program 110a, 110b may search the internet and may provide the user with updated weather information. The cognitive suggestion program 110a, 110b may consider the party's location, as well as its current climate information, in determining suitable cosmetics to keep the user comfortable while in Vizag.

The user may input information into the cognitive suggestion program 110a, 110b by issuing voice commands into the mobile application or IoT enabled mirror. The mirror or application may also pose verbal questions to the user and the user may verbally respond. Natural language processing techniques may be utilized to capture the user's response and convert the user's response into a format that is recognizable by the cognitive suggestion program 110a, 110b. For example, where the cognitive suggestion program 110a, 110b recognizes commands spoken in English, natural language processing techniques may be utilized for users that do not speak English, to convert their spoken commands into recognizable format. The user may also input information into a text box in the mobile application or may select from a list of available options in a drop-down window.

Continuing with the above example, Christina inputs her geographic location, skin type, and current inventory into the cognitive suggestion program 110a, 110b by responding to verbal questions posed by her mirror. She also uploads a photograph of herself by connecting the mirror to her cloud repository and selecting an accurate photograph of herself contained within the cloud repository.

At 206, the cognitive suggestion program 110a, 110b determines suitable products for the program's user. Based on the information received at 204, including inputted or uploaded photographs and event and climate information, the cognitive suggestion program 110a, 110b may analyze the skin type of the user and may determine suitable products. Analysis of the user's skin type may utilize image processing and image comparison techniques. Analysis of the user's skin type may further utilize a database of health and skincare related information (e.g., database 114), including pigmentation types, skin disorders, and treatment benefits, among other information. The database of health and skincare related information may be preprogrammed with health and skincare related information by the cognitive suggestion program 110a, 110b. The cognitive suggestion program 110a, 110b may alternatively, or additionally, utilize IBM's Watson™ (Watson and all Watson-based trademarks are trademarks or registered trademarks of International Business Machines Corporation in the United States, and/or other countries) application programming interface (API) to connect to an online skincare data system with up-to-date health and skincare information, or an online beauty store for access to new products. Watson™ may be utilized to analyze the user's information, including processing and comparing user images, and to generate predictions on suitable products and skincare routines.

Determining a suitable product for the program's user may require the cognitive suggestion program 110a, 110b to consider the user's skin type, climatic conditions, and duration of an event, before suggesting a suitable product. Climatic conditions may include weather and precipitation, based on an inputted geographic location. Considering climatic conditions in conjunction with the user's skin type may avoid suggesting products which will have a negative effect or appearance, given the user's environment.

Continuing with the previous example, the cognitive suggestion program 110a, 110b will consider the local temperature change and Christina's tendency to have chapped skin in colder months, and will recommend that she use a heavier moisturizer. Based on the photograph inputted by Christina, the cognitive suggestion program 110a, 110b further determines that Christina has puffiness surrounding her eyes and will suggest that she use a second moisturizer to reduce the puffiness.

At 208, the cognitive suggestion program 110a, 110b outputs suggestions to the user. The determined suitable products generated by the cognitive suggestion program 110a, 110b at 206 may be outputted to the user in written format in the interface of the cognitive suggestion program 110a, 110b, or may be sent via email to the address on file for the user. An output which populates in the interface of the cognitive suggestion program 110a, 110b may include a list of text listing each recommended product, and a description of the product beneath or to the right of the text. Each product on the list of recommended products may be linked to a website where the user may read more information about the recommended product, see pictures of the recommended product, search through reviews of the recommended product, or purchase the recommended product. Likewise, an email may include the previously mentioned text information, as well as click-through links to online websites which sell the recommend products. The determined suitable products generated by the cognitive suggestion program 110a, 110b may also be outputted in verbal format and may be spoken to the user in the same manner as questions posed previously at 204.

The cognitive suggestion program 110a, 110b may further output to the user a list of compositions of the suitable products. Based on the outputted list of compositions, the user may make a determination as to what product best suits his or her needs. The user determination may be made based on allergies or aversions to ingredients contained within a recommended product.

The cognitive suggestion program 110a, 110b may reference inputted and stored images within a user image database (e.g., database 114), as described previously at 204, and may compare the stored images to the database of health and skincare information or may compare the stored images to web information made available to the cognitive suggestion program 110a, 110b via the Watson™ API. The cognitive suggestion program 110a, 110b may then output to the user any indication of potential skin disorders or skincare solutions which appear to not be effective. This output may be accompanied by a modified skin care regimen or new recommendation.

Lastly, the cognitive suggestion program 110a, 110b may exclude from its recommendation any products which the user has previously indicated displeasure with (e.g., by providing feedback within the cognitive suggestion program 110a, 110b interface after use of the poorly recommended product).

In Christina's case, the IoT enabled mirror will verbally issue the determined recommendations to Christina, and will additionally send an email to her preferred address. The email is sent as a result of Christina's configured preference, which was made at the time of her registration with the cognitive suggestion program 110a, 110b, although Christina may elect to change this preference at any time.

According to another embodiment, the cognitive suggestion program 110a, 110b may receive as input allergies of the program's user at 204, and may exclude from its outputted list at 208 any products to which the user is allergic.

Referring now to FIG. 3, an example graphical user interface (GUI) 300 of the cognitive suggestion program 110a, 110b according to at least one embodiment is depicted. When a user of the cognitive suggestion program 110a, 110b launches the application on his or her smartphone, as discussed previously at 202, the user may be prompted to input information regarding the event the user is attending, the duration of the event, the event location, the user's inventory of cosmetic products, and photographs that accurately portray the user's skin type and complexion, as discussed previously at 204. The user may alternatively indicate that he or she wishes to purchase a new product and may use the cognitive suggestion program 110a, 110b to obtain information on cosmetic products outside of the user's inventory that may be suitable. Together with the gathered information, the cognitive suggestion program 110a, 110b may use image processing technology, as described previously at 206, to recommend a product that best suits the user's needs.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 4. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the cognitive suggestion program 110a in client computer 102, and the cognitive suggestion program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the cognitive suggestion program 110a and 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the cognitive suggestion program 110a in client computer 102 and the cognitive suggestion program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the cognitive suggestion program 110a in client computer 102 and the cognitive suggestion program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926, and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

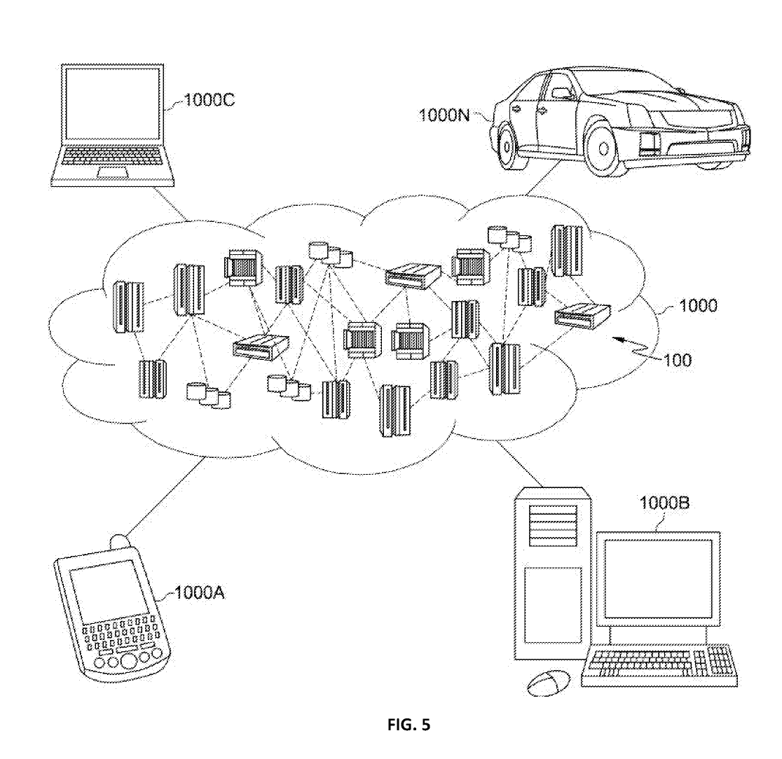

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

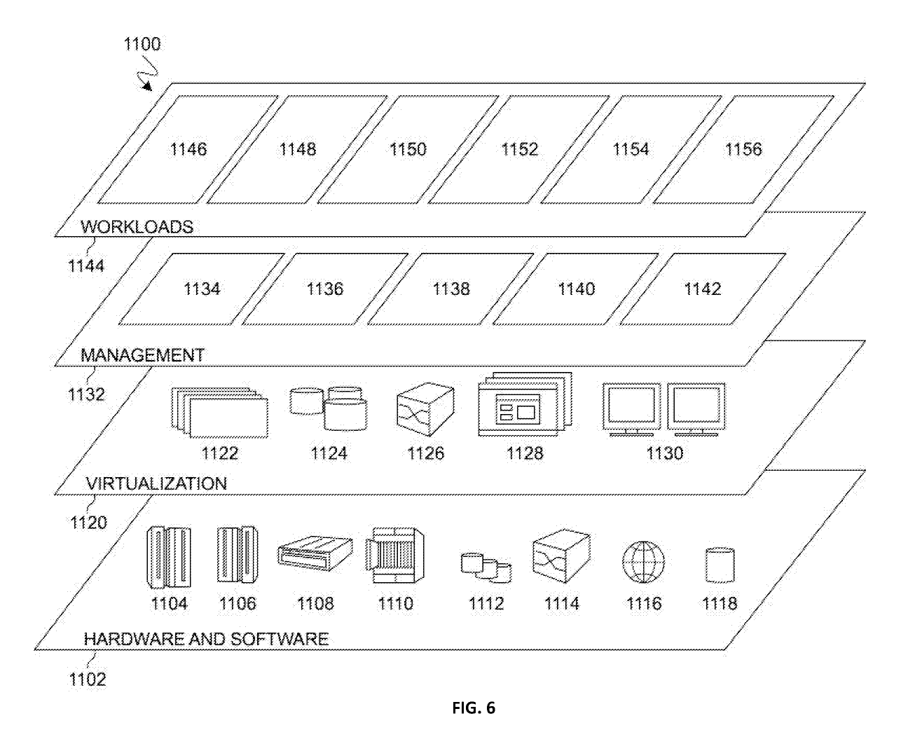

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and cognitive suggestion 1156. A cognitive suggestion program 110a, 110b provides a way to utilize a cognitive solution and image processing technologies to read the skin type of a user and output a list of products and compositions that may be suitable for the user based on the user's characteristics and needs.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for cognitive beauty suggestions, the method comprising:
launching a cognitive beauty suggestion application;
receiving a plurality of user data from a user of the cognitive beauty suggestion application;
determining one or more suitable products based on the received plurality of user data; and
outputting a list of the determined one or more suitable products to the user of the cognitive beauty suggestion application.

2. The method of claim 1, wherein the launched cognitive beauty suggestion application uses a platform, and wherein the platform is selected from the group consisting of a smartphone, a tablet, and an IoT enabled mirror.

3. The method of claim 1, wherein launching the cognitive beauty suggestion application includes launching the cognitive beauty suggestion application in response to receiving a voice command.

4. The method of claim 1, wherein the received plurality of user data from the user of the cognitive beauty suggestion application comprises a plurality of photographic data, a plurality of complexion data, a plurality of inventory data, and a plurality of geographic data.

5. The method of claim 1, wherein determining the one or more suitable products based on the received plurality of user data further comprises:
comparing the received plurality of user data to a linked database of health and skincare information.

6. The method of claim 1, wherein determining the one or more suitable products based on the received plurality of user data includes considering a user skin type, a climatic condition, and an event duration.

7. The method of claim 1, wherein outputting the list of the determined one or more suitable products to the user of the cognitive beauty suggestion application includes an output mode, and wherein the output mode is selected from the group consisting of populating in an application interface, generating an email, and issuing a voice command.

8. A computer system for cognitive beauty suggestions, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
launching a cognitive beauty suggestion application;
receiving a plurality of user data from a user of the cognitive beauty suggestion application;
determining one or more suitable products based on the received plurality of user data; and
outputting a list of the determined one or more suitable products to the user of the cognitive beauty suggestion application.

9. The computer system of claim 8, wherein the launched cognitive beauty suggestion application uses a platform, and wherein the platform is selected from the group consisting of a smartphone, a tablet, and an IoT enabled mirror.

10. The computer system of claim 8, wherein launching the cognitive beauty suggestion application includes launching the cognitive beauty suggestion application in response to receiving a voice command.

11. The computer system of claim 8, wherein the received plurality of user data from the user of the cognitive beauty suggestion application comprises a plurality of photographic data, a plurality of complexion data, a plurality of inventory data, and a plurality of geographic data.

12. The computer system of claim 8, wherein determining the one or more suitable products based on the received plurality of user data further comprises:
comparing the received plurality of user data to a linked database of health and skincare information.

13. The computer system of claim 8, wherein determining the one or more suitable products based on the received plurality of user data includes considering a user skin type, a climatic condition, and an event duration.

14. The computer system of claim 8, wherein outputting the list of the determined one or more suitable products to the user of the cognitive beauty suggestion application includes an output mode, and wherein the output mode is selected from the group consisting of populating in an application interface, generating an email, and issuing a voice command.

15. A computer program product for cognitive beauty suggestions, comprising:
one or more computer-readable storage media and program instructions stored on at least one of the one or more tangible storage media, the program instructions executable by a processor to cause the processor to perform a method comprising:
launching a cognitive beauty suggestion application;
receiving a plurality of user data from a user of the cognitive beauty suggestion application;
determining one or more suitable products based on the received plurality of user data; and
outputting a list of the determined one or more suitable products to the user of the cognitive beauty suggestion application.

16. The computer program product of claim 15, wherein the launched cognitive beauty suggestion application uses a platform, and wherein the platform is selected from the group consisting of a smartphone, a tablet, and an IoT enabled mirror.

17. The computer program product of claim 15, wherein launching the cognitive beauty suggestion application includes launching the cognitive beauty suggestion application in response to receiving a voice command.

18. The computer program product of claim 15, wherein the received plurality of user data from the user of the cognitive beauty suggestion application comprises a plurality of photographic data, a plurality of complexion data, a plurality of inventory data, and a plurality of geographic data.

19. The computer program product of claim 15, wherein determining the one or more suitable products based on the received plurality of user data further comprises:
comparing the received plurality of user data to a linked database of health and skincare information.

20. The computer program product of claim 15, wherein determining the one or more suitable products based on the received plurality of user data includes considering a user skin type, a climatic condition, and an event duration.
